(19) United States
(12) Patent Application Publication
(10) Pub. No.: US 2014/0118146 A1
(43) Pub. Date: May 1, 2014

(54) INTELLIGENCE IC LOCK

(71) Applicant: JEN-CHIH LIU, Kaohsiung (TW)

(72) Inventor: JEN-CHIH LIU, Kaohsiung (TW)

(21) Appl. No.: 13/663,480

(22) Filed: Oct. 30, 2012

(51) Int. Cl. G06F 7/04; G08B 13/22

(52) U.S. Cl. 340/572.1; 340/5.61

(57) ABSTRACT

An intelligence IC lock combines a touch panel of human-machine interface and a noncontact RFID chip card, reader device, password input circuit, identification unit, data processing unit, monitor and auto-dial unit, battery monitor unit, and CANBus(Control Area Network Bus). The chip card has functions of identification, value-stored, and calculation which the account of the card is rebuildable and theft-proof. With the functions mentioned above, the intelligence IC lock is applied to entrance management, retail system, and vehicle control.

### FIELD OF THE INVENTION

The present invention relates to IC card, and particular to a IC lock having a noncontact RFID chip card, reader device, password input circuit, identification unit, data processing unit, monitor and auto-dial unit, battery monitor unit, CANBus. Functions of auto-dialing and warning through a smart phone can be achieved with the IC lock.

### DESCRIPTION OF THE PRIOR ART

Besides the credit card, so called plastic or electric money becomes more and more popular nowadays.

Normally, the ownership of such stored-value card can not be verified. Anyone can grab the card and use the card, the stored-value within the card can not be retrieved upon lost. Even the stored-value function embedded to a credit card doesn't have any process to verify the ownership upon usage of the stored-value function. Anyone found the lost card can continuously consume the stored-value in the card without any problem which is not fair and unreasonable. Other similar stored-value card for chain coffee store or an air condition card in a school also have the same problem.

Entrance guard for hotels or buildings is also done by IC card or IC key. A lost IC key could lead to a theft or danger to the house or other people stay in the building.

The IC keys have also taking the place of conventional key for vehicles nowadays. However, the system can only verify the key but not the user or the authorization of usage. The engine can be started by the key or shorting the start battery by anyone.

Some IC key of the electric vehicles can also be used to charge the battery at a charging station. Without the ownership identification, a stolen vehicle with the Key will cause double loss to the owner.

Therefore, the disadvantage of the IC card mentioned above need an immediate solution.

### SUMMARY OF THE PRESENT INVENTION

Accordingly, the primary object of the intelligence IC lock of the present invention is to provide an identification and verification function to an IC card for the purpose to prevent misappropriating or steal.

The secondary object of the intelligence IC lock of the present invention is to provide stored-value function and calculating function to the IC card used for entrance guard, retail system, vehicle control and relative applications.

To achieve above objects, the intelligence IC lock combines a noncontact RFID chip card, reader device, password input circuit, data processing unit, monitor and alarm unit, current monitor unit, and CANBus (Control Area Network Bus).

The IC chip of the intelligence IC lock has functions of identification, value-stored, and calculation, and the account of the lock can be rebuilt upon lost. With the functions, the intelligence IC lock can be applied to entrance management, retail system, and vehicle control.

### BRIEF DESCRIPTION OF THE DRAWINGS

FIG. 1 is a diagram of the present invention.

FIG. 2 is a system diagram showing the recognition system of the present invention.

FIG. 2-1 is a diagram showing an application of the present invention to a vehicle.

FIG. 3 is a system diagram showing a card setup and value-adding of the present invention.

FIG. 4 is a flow chart showing the value-adding and payment of the present invention.

FIG. 5 is a schematic view showing an application of vehicle control of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The intelligence IC lock according to the present invention includes a RFID chip for storage, identification, and calculating, human-machine interface of a touch panel, reader device, password input unit, data processing unit, monitor and alarm unit, current control unit, and CANBus(Control Area Network Bus).

The human-machine interface, digital signal process chip, network communication chip, and network manage chip are hardware. The human-machine interface is combined by a single chip digital signal processor and the Ethernet interface (Combined CANBus and Ethernet). The RFID chip includes a RF identification circuit, encryption\decryption system, and encoder and password verification system. Unused memory space within the Mifare electric label can be used to store password. User can define 6 digits or letters as a private password so that the chip will have three kinds of password which are maintenance code for maintenance purpose, user account code, and private password. The user account code is the user account number can be reset through maintenance code once forgotten. The private password can be obtained upon receiving of the chip and also can be changed through human-machine interface.

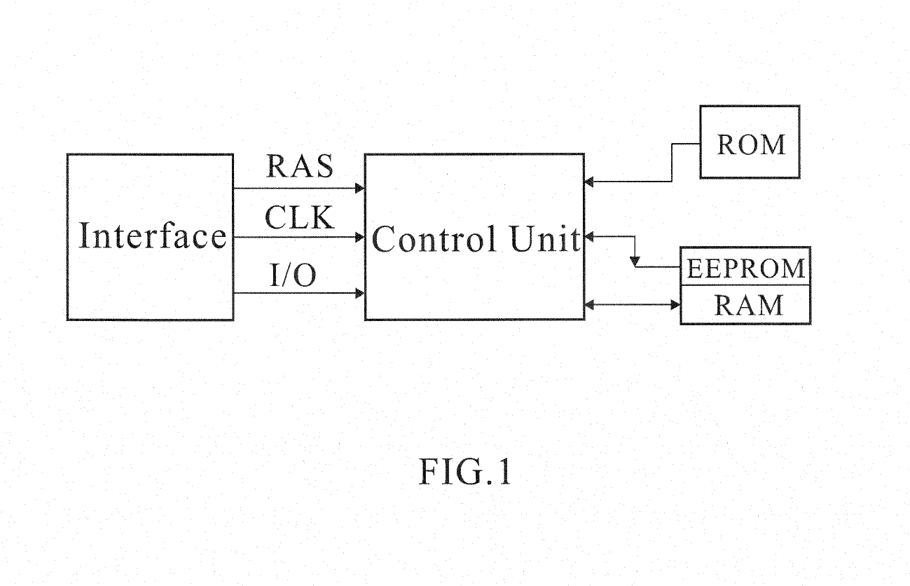

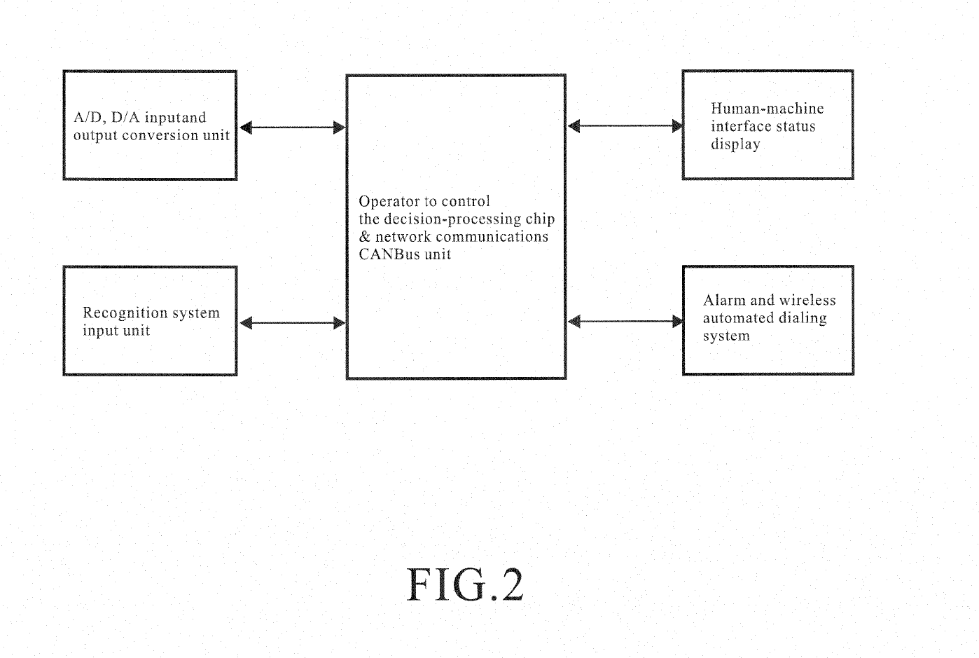

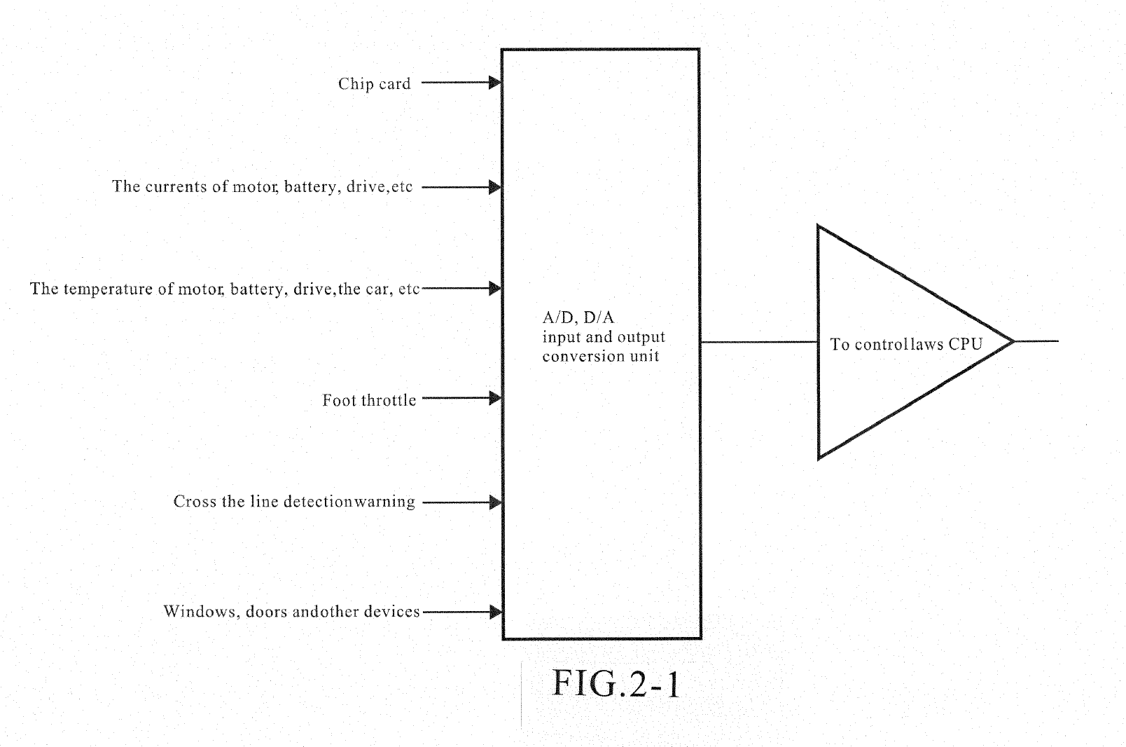

Referring to FIG. 1, a diagram showing the interconnection of the chip is illustrated. User has to input the user account code and private password from the human-machine interface before a further operation. Otherwise, an alarm will be activated. Referring to FIG. 2, a diagram showing the recognition system is illustrated. For example, to start a car through the IC card, user must input correct password. Otherwise, a failed input of password will cause an alarm sent to the car owner. The start of the car is not controlled by an auxiliary power which could be easily disarmed by shorting the power. The recognition system can be used for the purpose to ensure the chip and the car are matched.

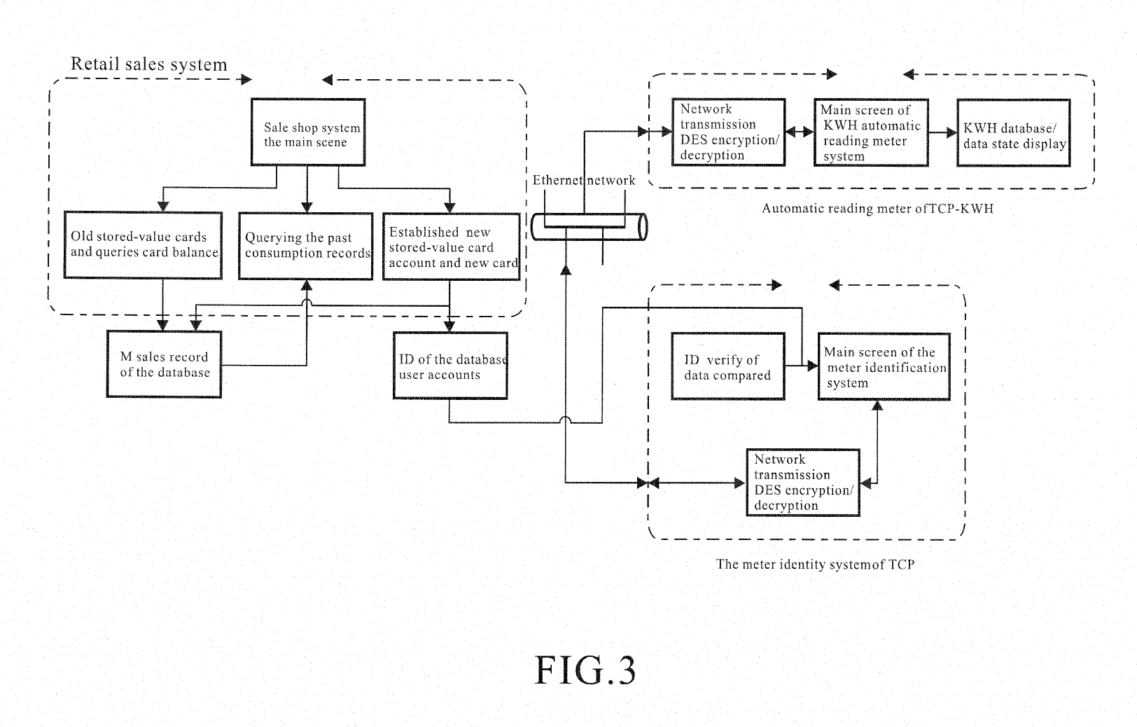

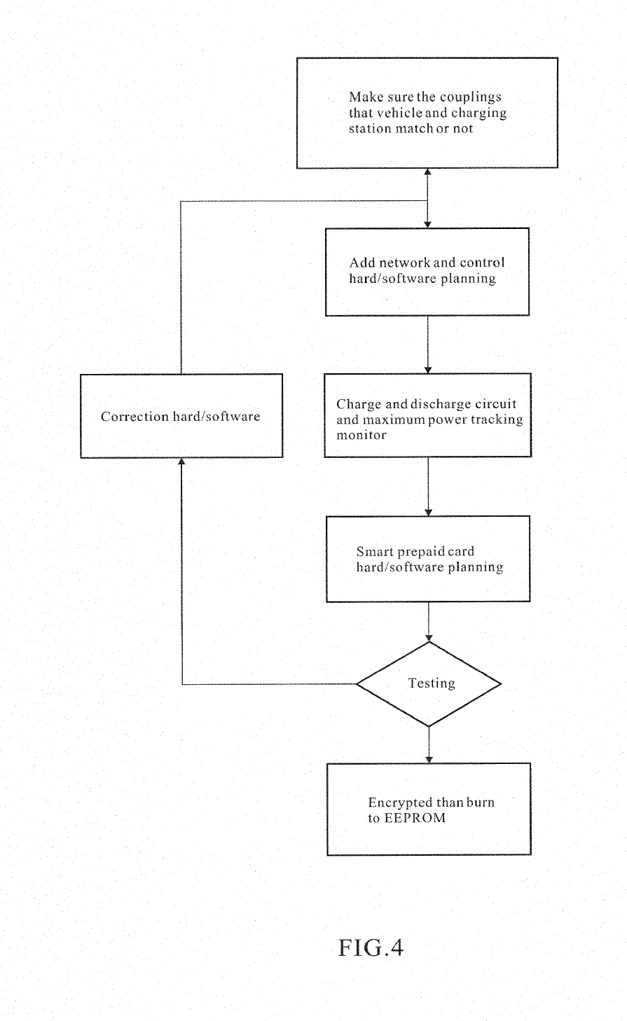

The password setting is divided into two parts. They are retail sales system and user's digital touch panel or intelligence network meter. Referring to FIG. 3, the retail sales system serves to establish new stored-value card and add value to the card. A purchased stored-value card is linked to the owner's account for following recognition and usage. The value-adding and payment operation are shown in FIG. 4.

The intelligence IC lock of the present invention can be applied to door entrance guard system. The chip and password should be presented and input correctly before entrance. If the password is not input correctly, the access won't be allowed and an alarm will be generated with a message sent to relative personnel.

The intelligence chip lock can be applied to commercial retail system. The owner can present the IC card and input correct password to perform value-adding, consuming, or payment. If the password is not input correctly, the operations won't be allowed and an alarm will be generated with a message sent to relative personnel.

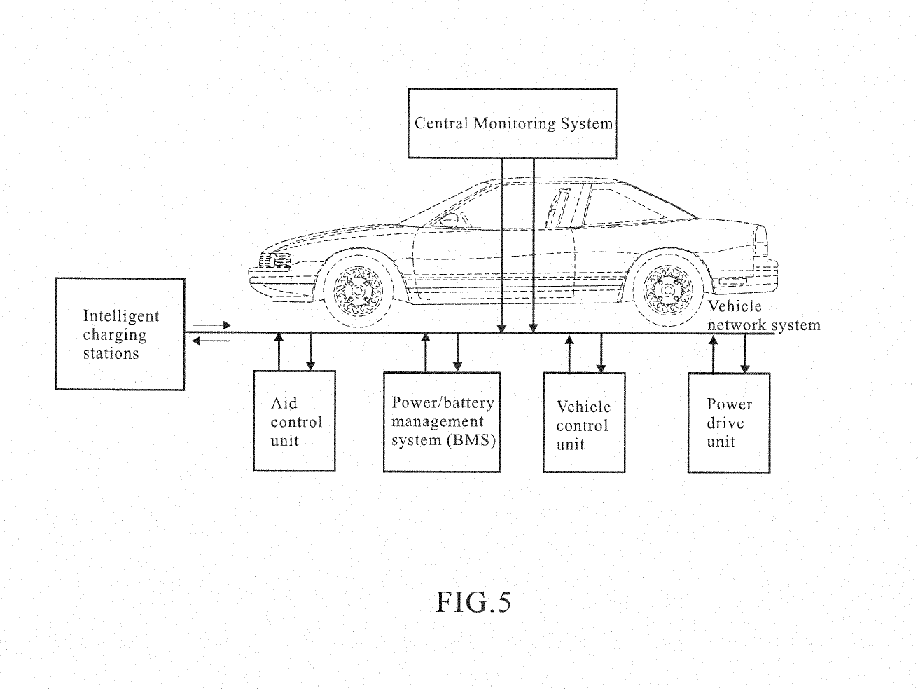

Referring to FIG. 5, the intelligence chip lock can be applied to vehicle control. Before starting an engine, the chip must be presented and correct password must be input. Once the password is verified by an internal computer through an internal network, the engine can be started. If the password is not input correctly, the operations won't be allowed and an alarm will be generated with a message sent to relative personnel.

The intelligence chip lock can be applied to vehicle charging station. By presenting the chip with correct password verified by the system, the charging of the vehicle can be started. If the password is not input correctly within certain tries, further operations won't be allowed and an alarm will be generated with a message sent to relative personnel.

Referring to FIGS. 2-1 and 5, an application of the present invention applied to a car are illustrated. After the door of a car is opened through the IC card, the user name and password must be input through the human-machine interface. After the user name and password is verified, the car engine can be started. Otherwise, the car engine will not start and an alarm is activated with a theft prevention. The prevention is to short the start auxiliary battery so as to discharge the battery. A message will also be sent to relative personnel for warning. After the engine is started, all status such as speed, motor rotation, motor temperature, battery, lamp, and door will be shown on the human-machine interface. Each control unit of the car is operated solely by its own processor and the status and result will be sent to a central processor through an internal network for overall control.

The IC card can be added value through a counter or a self-service machine in a parking, toll station, or charging station. With a matched user name and password, user can add value to the account and also use the value for charging at a charging station. A wrong password will cause an alarm and suspending of the account.

The intelligence IC card on the user end has the function of charging fee calculation, power factor detection, charging history, tachograph history, user identification, and auto-debiting. The account of the IC card or value storage of the card is shown in FIG. 3. The retail system based on Microsoft Visual C++ 2005 program combines three sections of card sales, identification, and card reading, calculating, and debiting.

The data in the IC card must be read through a card reader. Before the data transferring, the data will be encrypted under a predetermined method so as to ensure the safety and privacy. The data inside the IC card renewed by software will be recorded in data base of the retail system so that user can use the card after user name and password verification.

Relative value adding and debiting processes are shown in FIG. 4. A monitor screen, battery current\voltage\temperature detection with alarm circuit (single chip LTC6802-2), charging monitor program to calculate power, PF, and voltage variation, and simulator are established by VB. During a charging, the battery voltage, current, and temperature are sampled and monitored. The battery status and charging progress are shown by the program. An interlock to cut the charging power will be generated while the temperature of the battery is over a predetermined limit so as to ensure the safety.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An intelligence IC lock comprising a RFID chip for storage, identification, and calculating, human-machine interface of a touch panel, reader device, password input unit, data processing unit, monitor and alarm unit, current monitor unit, and CANBus(Control Area Network Bus);
wherein the human-machine interface, digital signal process chip, network communication chip, and network manage chip are hardware; the human-machine interface includes a single chip digital signal processor; the RFID chip includes a RF identification circuit, encryption\decryption system, and encoder and password verification system; unused memory space within the Mifare electric label can be used to store password.

2. The intelligence IC lock as claimed in claim 1, wherein the touch panel of the human-machine interface is a touch panel of a smart phone or any other devices.

3. The intelligence IC lock as claimed in claim 1, wherein the touch panel of human-machine interface is operated by a smart phone.

4. An intelligence IC lock comprising a RFID chip for storage, identification, and calculating, human machine interface on a touch panel, reader device, password input unit, data processing unit, monitor and alarm unit, current monitor unit, and CANBus(Control Area Network Bus);
wherein the human-machine interface, digital signal process chip, network communication chip, and network manage chip are hardware; the human-machine interface includes a single chip digital signal processor; the RFID chip includes a RF identification circuit, encryption\decryption system, and encoder and password verification system; unused memory space within the Mifare electric label can be used to store password; the intelligence IC lock is applied to vehicle control; the door of a car is opened by the IC lock, and the user name and password must be input through the human-machine interface so as to verify the identity of user; the engine is able to be started upon a successful verification and then status of each control unit of the car will be shown on the human-machine interface.

5. The intelligence IC lock as claimed in claim 4, wherein the car engine will not start and an alarm will be activated with a theft prevention if the user name and password no matched; the prevention is to short the start auxiliary battery so as to discharge the battery; a message will also be sent to relative personnel for warning.

6. The intelligence IC lock as claimed in claim 4, wherein all status of the car such as speed, motor rotation, motor temperature, battery, lamp, and door will be shown on the human-machine interface once the user verification pass;
each control unit of the car is operated solely by its own processor and the status and result will be sent to a central processor through an internal network for overall control.

7. The intelligence IC lock as claimed in claim 4, wherein the touch panel of the human-machine interface is a touch panel of a smart phone or any other devices.

8. The intelligence IC lock as claimed in claim 4, wherein the touch panel of human-machine interface is operated by a smart phone.
